(19) United States
(12) Patent Application Publication
(10) Pub. No.: US 2014/0172947 A1
(43) Pub. Date: Jun. 19, 2014

(54) CLOUD-BASED VIRTUAL LOCAL NETWORKS

(71) Applicant: BENU NETWORKS, INC., Billerica, MA (US)

(72) Inventors: Rajat GHAI, Sandwich, MA (US); David F. CALLAN, Swampscott, MA (US); Rajendar DUGGAL, Lincoln, MA (US); Swarup SAHOO, Acton, MA (US); Shawn LEWIS, Billerica, MA (US); John DEPIETRO, Sandwich, MA (US); Patrick BOWEN, Billerica, MA (US); Ramesh GUPTA, Acton, MA (US)

(73) Assignee: BENU NETWORKS, INC., Billerica, MA (US)

(21) Appl. No.: 14/109,263

(22) Filed: Dec. 17, 2013

Related U.S. Application Data
(60) Provisional application No. 61/738,300, filed on Dec. 17, 2012.

(51) Int. Cl. H04L 29/06

(52) U.S. Cl. CPC H04L 65/102
USPC 709/202

(57) ABSTRACT

Systems and methods are described for providing cloud-based virtual local networks. A computerized method for providing cloud-based virtual local networks includes receiving at a network gateway a request for a network address from a network switch, communicating with a user device management entity (uDME) server to authorize the network switch, receiving an authorization response from the uDME server for the network switch, receiving a network address pool at the network gateway from the uDME server, and creating at the network gateway a virtual home router containing a virtual home router context that is unique to the virtual home router and associated with the network address pool.

### RELATED APPLICATIONS

This application claims priority to U.S. Provisional Patent Application No. 61/738,300 filed on Dec. 17, 2012, the content of which is incorporated herein by reference in its entirety.

### BACKGROUND

Cloud computing is a model for enabling ubiquitous, convenient, on-demand network access to a shared pool of configurable computing resources (e.g., networks, servers, storage, applications, and services) that can be rapidly provisioned and released with minimal management effort or service provider interaction.

A cloud infrastructure is the collection of hardware and software that enable the five essential characteristics of cloud computing, namely on-demand self-service, broad network access, resource pooling, rapid elasticity, and measured service. The cloud infrastructure can be viewed as containing both a physical layer and an abstraction layer. The physical layer can consist of the hardware resources that are necessary to support the cloud services being provided, and can typically include server, storage and network components. The abstraction layer can consist of the software deployed across the physical layer, which can manifest the essential cloud characteristics. Conceptually the abstraction layer can sit above the physical layer. Cloud infrastructure and computing can create operational efficiencies and configuration flexibility due to aggregation and polling of resources that are shared by end users/devices.

Service providers can provide cloud services to their subscribers over variety of access networks (AN). Basic categorization of access networks include wireline (also called fixed broadband) and wireless (also known as mobile networks). Wireline networks can comprise of cable, DSL and optical access networks etc. Wireless access networks can comprise of WiFi, 3G, 4G access networks, etc. IP Networking as a Service (NaaS) is service model where a fixed broadband service provider adopts a cloud-computing model to IP networking service for home/business dwellings.

A Public Land Mobile Network (PLMN) is generally a wireless network operated by recognized and authorized organizations called wireless service providers. A PLMN can use radio waves in licensed spectrum to create a telecommunication network for providing mobile telecommunications service to the public. A mobile service can provide continuous connectivity amongst mobile devices or between mobile devices to a fixed network.

PLMNs can use cellular telephony that is generally characterized by the use of radio cells that provide radio coverage for a geographic area, with multiple cells arranged to provide contiguous radio coverage over a larger area. Wired communication can be used in portions of a PLMN, such as between cells, access points, or gateways to create entry/exit points to the Internet. A typical PLMN can include an access network (AN) that is specific to wireless technologies and a core network (CN) that performs routing of mobile communication within the PLMN or from PLMN to extern packet data networks (PDN), e.g., the Internet.

PLMNs have evolved over the years following the advancements in cellular technologies. The first generation (1G) cellular technology used analog mobile phones in which analog information signals were modulated and transmitted. The second generation (2G) systems used digital modulation of the information signals to provide more dense and robust wireless systems. Among the many 2G wireless technologies, the most prevalent ones used code division multiple access (CDMA) technologies for IS-95 systems or time division multiplex access (TDMA) technology for GSM systems to distinguish multiple users. 2G wireless networks are primarily used for speech communication. With the advent of the Internet and the demand to access the Internet from portable mobile devices, CDMA based networks were further upgraded to handle higher-speed packet data using CDMA 1x-EVDO in networks referred to as 2.5G while GSM based networks were upgraded to GPRS/EDGE and then HSPA as 3G networks. 3G networks are evolving to 4G technology, which is referred to as long term evolution-system architecture evolution (LTE-SAE) and uses orthogonal frequency division multiple access (OFDMA) technology. Other 4G wireless technologies have also developed including WiMAX (an implementation of IEEE 802.16), Wi-Fi (an implementation of various IEEE 802.11 protocols), and HiperMAN, which is based on an ETSI alternative to IEEE 802.16. 4G networks are based on IP (Internet Protocol) technology to facilitate ultrafast IP packet transmission services.

The range of the wireless communication technology can vary depending on the deployment of the PLMN. A macro cell transceiver is typically used by service providers to provide coverage over about three miles. A pico cell transceiver can provide coverage over about a quarter mile while a femto cell transceiver can provide coverage over 50 to 100 yards that is similar in coverage to a Wi-Fi (WLAN) access point and can be used to provide network access over a short range.

PLMNs use wireless communication technologies to provide speech and data communication services to mobile/portable devices e.g. laptop and notebook computers with many applications (e.g. web browsers to access the Internet), portable digital assistants (PDAs), and bespoke mobile devices (e.g., cellular telephones, user equipment). Users, authorized for the wireless service, can connect to a network (e.g., the Internet) as long as the user is within range of such a wireless communication technology.

For the PLMNs, a part of the evolution of packet based communications has been the development of a core network capable of routing IP based data communication within a PLMN (mobile to mobile) or PLMN to an external network (e.g. mobile to the Internet). IP packet core network functionality can be developed by three different groups for inclusion in two different topologies: Global System for Mobile Communications (GSM), CDMA 2000, and WiMAX. The 3^{rd} Generation Partnership Project (3GPP) is responsible for General Packet Radio Service (GPRS) which works with GSM/LTE systems, the 3rd Generation Partnership Project 2 (3GPP2) is responsible for High Rate Packet Data (HRPD) which is used with CDMA systems and WiMAX forum responsible for Access Service Network (ASN) and Connectivity Service Network (CSN).

For 3G UMTS based technologies, such a packet core network is referred to as GPRS (General packet radio service) CN. GPRS is an architectural framework for delivering internet protocol (IP) transmission services to mobile nodes. Main components of a GPRS core network that provide packet services are a SGSN (Serving GPRS Service Node) and a GGSN (Gateway GPRS Service Node). A SGSN manages initial authentication, authorization, mobility, IP session establishment and charging aspects of packet data communications for the mobile nodes. A GGSN manages IP address allocation to the mobile nodes, gathers charging details for the amount of data packets transmitted by the mobile nodes, enforces policies of the PLMN operator, and provides connectivity to external packet data networks (PDNs) such as the Internet.

For LTE based technologies, such a packet core network is referred to as Evolved Packet Core (EPC). EPC is an architectural framework for delivering internet protocol (IP) transmission services to mobile nodes. Main components of an EPC core network that provide packet services are a Mobility Management Entity (MME), a Serving Gateway (SGW), and a PDN Gateway (PGW). The MME manages initial authentication, authorization, mobility, IP session establishment and charging aspects of packet data communications for the mobile nodes. The SGW and PGW manage IP address allocation to the mobile nodes, gather charging details for the amount of data packets transmitted by the mobile nodes, enforce policies of the PLMN operator, and provide connectivity to external packet data networks (PDNs). In a CDMA based HRPD core network, the Packet Data Service Node (PDSN) and Home Agent (HA) provide the architectural framework for delivering internet protocol (IP) transmission services to the mobile node. In a WiMAX core network, Access Service Network Gateway (ASN-GW), Core Service Network Gateway (CSN GW), or HA provides the architectural framework for delivering IP transmission services to the mobile node. In a WiFi core network, the Wi-GW (Wireless Access Gateway) provides the architectural framework for delivering IP transmission services to the mobile node.

Traditionally, home networking is supported by a home router (a.k.a., home gateway, or customer premise equipment (CPE), etc.) located in the premise of a user (e.g., inside a user's home). The conventional home networking mechanism has some shortcomings. First, it lacks flexibility and mobility. A user device (e.g., a laptop computer or a smartphone) generally has to be located in or around the user's premise to connect to the user's home network. If the user travels with the user device far away from the user's home, the user device will not be able to connect to the user's home network and access the resources available only within the home network (e.g., printing, content server, uPnP server, etc.). Second, it is difficult to manage. The home router is usually the only device visible from outside the user's home. It's thus difficult and sometimes impossible to diagnose, configure, or manage individual user devices behind the home router. Third, it increases the user cost. Each user's home needs to have a router capable of routing the network traffic in and out the home network.

### SUMMARY

In accordance with the disclosed subject matter, systems and methods are described for cloud-based virtual local networks.

Disclosed subject matter includes, in one aspect, a computerized method for providing cloud-based virtual local networks, which includes receiving at a network gateway a request for a network address from a network switch, communicating with a user device management entity (uDME) server to authorize the network switch, receiving an authorization response from the uDME server for the network switch, receiving a network address pool at the network gateway from the uDME server, and creating at the network gateway a virtual home router containing a virtual home router context that is unique to the virtual home router and associated with the network address pool.

In some embodiments, the network switch is located in a premise of a user.

In some other embodiments, the network address is an IP address.

In some other embodiments, the virtual home router is a virtual IP router.

In some other embodiments, the network address pool is an IP address pool.

In some other embodiments, the computerized method for providing cloud-based virtual local networks also includes authorizing the network switch based on a policy.

In some other embodiments, the computerized method for providing cloud-based virtual local networks also includes receiving at the network gateway a medium access control (MAC) address of the network switch, and sending the MAC address of the network switch to the uDME server for authorizing the network switch.

In some other embodiments, the computerized method for providing cloud-based virtual local networks also includes receiving class of service (COS) information from the uDME server.

In some other embodiments, the computerized method for providing cloud-based virtual local networks also includes receiving at the network gateway a second request for a second network address from a user device connected to the network switch, authorizing the user device for network access, associating the user device with the virtual home router at the network gateway, allocating the second network address from the network address pool associated with the virtual home router, and notifying the uDME server of a status of the user device.

In some other embodiments, the second request is encapsulated and forwarded by the network switch.

In some other embodiments, the computerized method for providing cloud-based virtual local networks also includes communicating with the uDME server to authorize the user device for network access.

In some other embodiments, the computerized method for providing cloud-based virtual local networks also includes authorizing the user device for network access based on a policy.

In some other embodiments, the computerized method for providing cloud-based virtual local networks also includes receiving at the network gateway a third request for a third network address from the user device when the user device is not connected to the network switch, authorizing the user device for network access, associating the user device with the virtual home router at the network gateway, allocating the third network address from the network address pool associated with the virtual home router, and notifying the uDME server of the status of the user device.

Disclosed subject matter includes, in another aspect, a network gateway for providing cloud-based virtual local networks, which includes an access network interface configured to receive a request for a network address from a network switch, a user device management entity (uDME) server interface configured to send an authorization request to an uDME server and receive an authorization response, and a virtual home router context manager configured to maintain at least one virtual home router context and create a virtual home router for the network switch based on the authorization response.

In some embodiments, the authorization response contains a network address pool for the virtual home router.

In some other embodiments, the authorization response contains class of service (COS) information.

In some other embodiments, the access network interface is further configured to receive a media access control (MAC) address of the network switch, and the uDME server interface is further configured to send the MAC address of the network switch for authorization.

In some other embodiments, the network gateway for providing cloud-based virtual local networks also includes a centralized virtual home router controller configured to configure at least one user device.

In some other embodiments, the network gateway for providing cloud-based virtual local networks also includes a device fingerprint manager configured to determine a device type of a user device.

In some other embodiments, the access network interface is further configured to receive a second request for a second network address from a user device connected to the network switch, the uDME server interface is further configured to authorize the user device for network access, and the virtual home router context manager is further configured to associate the user device with the virtual home router.

In some other embodiments, the uDME server interface is further configured to notify the uDME server of a status of the user device.

Disclosed subject matter includes, in yet another aspect, a network server for providing cloud-based virtual local networks, which includes a network gateway interface configured to communicate with a network gateway supporting virtual home routers, an operator network server interface configured to communicate with an operator network server, a subscription manager configured to manage subscriptions of a plurality of users, a network address pool manager configured to manage network address pools for a plurality of virtual home routers, a virtual home manager configured to manage a plurality of virtual homes, and a user device manager configured to manage a plurality of user devices.

In some embodiments, the network server for providing cloud-based virtual local networks also includes a third-party server interface configured to communicate with a third-party server to provide additional services to user devices coupled to a virtual home router.

Various embodiments of the subject matter disclosed herein can provide one or more of the following capabilities. Cloud-based virtual local networks can improve flexibility and mobility, provide easy and robust management, and reduce initial and operating cost of local networks. In one illustrative example, point-to-point (P2P) encapsulated connections can connect user devices to a virtual local network provided by a network gateway. User devices in different physical locations can join a same virtual local network; user devices in a same physical location can join different virtual local networks. Network intelligence can be moved out of user premises and into a centralized managed network gateway.

These and other capabilities of embodiments of the disclosed subject matter will be more fully understood after a review of the following figures, detailed description, and claims.

### BRIEF DESCRIPTION OF THE DRAWINGS

FIG. 1 illustrates an exemplary conventional home networking arrangement.

FIG. 2 illustrates an exemplary home networking arrangement.

FIG. 3 illustrates another exemplary home networking arrangement.

FIG. 4 illustrates another exemplary home networking arrangement.

FIG. 5 illustrates an exemplary process of establishing connection between a network switch and a network gateway.

FIG. 6 illustrates an exemplary process of establishing connection between a user device and a network gateway.

FIG. 7 illustrates another exemplary process of establishing connection between a user device and a network gateway.

FIG. 8 illustrates an exemplary state diagram of virtual home routers.

FIG. 9 illustrates an exemplary environment of a virtual local network and the user devices.

FIG. 10 contains a block diagram of an exemplary network gateway.

FIG. 11 contains a block diagram of an exemplary user device management entity (uDME) server.

FIG. 12 contains a block diagram of an exemplary computing device.

### DESCRIPTION

In the following description, numerous specific details are set forth regarding the systems and methods of the disclosed subject matter and the environment in which such systems and methods may operate, in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the embodiments described below are only examples, and that it is contemplated that there are other systems and methods that are within the scope of the disclosed subject matter.

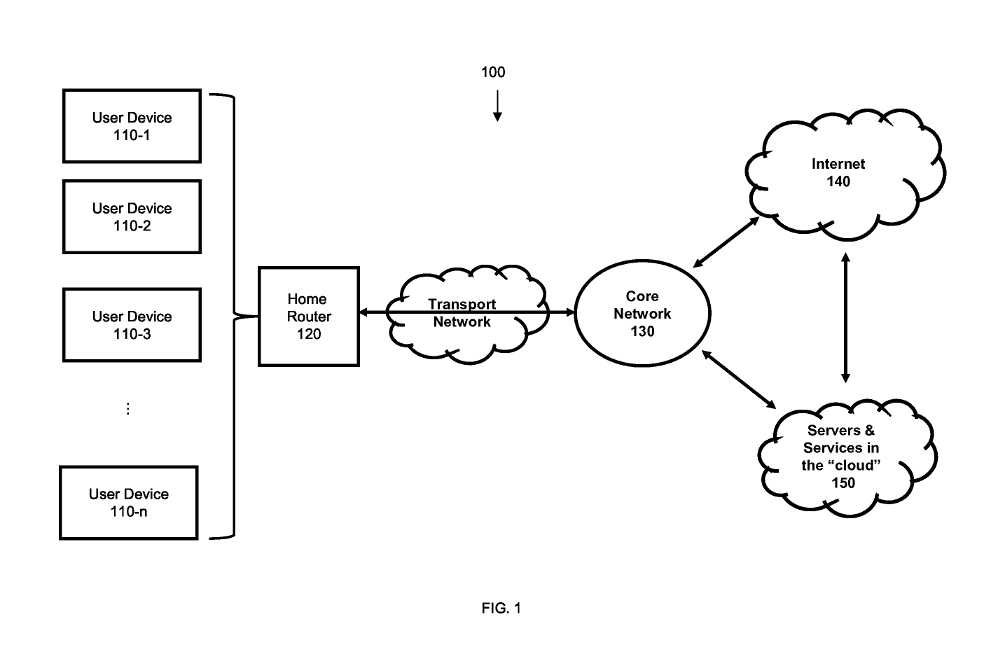

FIG. 1 illustrates an exemplary conventional home networking arrangement 100. The arrangement 100 can include one or more user devices 110-1, 110-2, 110-3, . . . 110-n, a home router 120, a core network 130, an Internet 140, and servers & services in the “cloud” 150. The reference number 110 can be used to refer to an user device individually or a group of user devices collectively. The one or more user devices can be any computing devices capable of accessing network services (e.g., laptop, desktop, tablet, smartphone, smart appliance, networked printer, etc.) The one or more user devices can be physically located in a user' premise (e.g., a home). The one or more user devices can connect to the outside world through the home router 120. The home router 120 can connect to the core network 130 though, e.g., a transport network. In some examples, the transport network can be a Level 2 IP transport network. The core network 130 can be a fixed broadband network operated by a network service provider. The core network 130 can connect to the Internet 140 and/or the servers & services in the “cloud” 150. The core network 130 can connect to the servers & services in the “cloud” 150 directly and/or through the Internet 140.

In the arrangement 100, the user device 110 usually needs to stay behind the home router 120 in the user's premise in order to access services in the user's home network (e.g., printing, content server, uPnP server, etc.). If the user device is relocated to a remote location, the user device will usually not be able to access the home network. In addition, from outside the home network (e.g., from the perspective view of the core network 130), only the home router 120 is visible. It's usually difficult and sometimes impossible for the core network 130 and other entities outside the home network to access, diagnose, or configure the one or more user devices 110 behind the home router 120. Furthermore, this arrangement usually requires an intelligent home router which supports routing and/or management capabilities for the one or more user devices 110. This can potential increase the initial and operating cost of home networks.

The disclosed subject matter can provide a solution that provides cloud-based virtual local networks. In one illustrative example, point-to-point (P2P) encapsulated connections between user devices and a network gateway can form a virtual local network supported by the network gateway. In one aspect, user devices in different physical locations can join a same virtual local network; user devices in the same physical location can join different virtual local networks. This can improve network flexibility and mobility. For example, a user device when relocated to a remote location can still join the same local network (e.g., its home network). In another aspect, network intelligence is moved out of a user's premise and into a centralized managed gateway. This can enable a “dumb edge-smart core” approach and help provide easy and robust management of user devices. In yet another aspect, this solution allows dumb/thin network switches (instead of fully-functional network routers) to be positioned in user's premises, thus reducing the initial and operating cost of local networks. In some embodiments, a centralized platform (e.g., a wireless gateway) can hosts virtual residential gateway contexts (one for every home/business) while the customer premise has a layer 2 (L2) switch that creates a virtual P2P tunnel from the customer premise to the centralized platform. The virtual home routing context can be the first IP hop as well as the IP Gateway for all the devices in the customer premise.

In some aspects, the disclosed subject matter can provide a solution for cloud-based managed home networking service over a wide area network. Embodiments of the disclosed subject matter can enable an Internet service provider to create a virtual point-to-point (P2P) layer 2 network from subscribers' homes to the service provider's core network over a wide area network. Distributed home IP networking in a virtualized environment can be formed seamlessly and securely by connecting one or many residential networks.

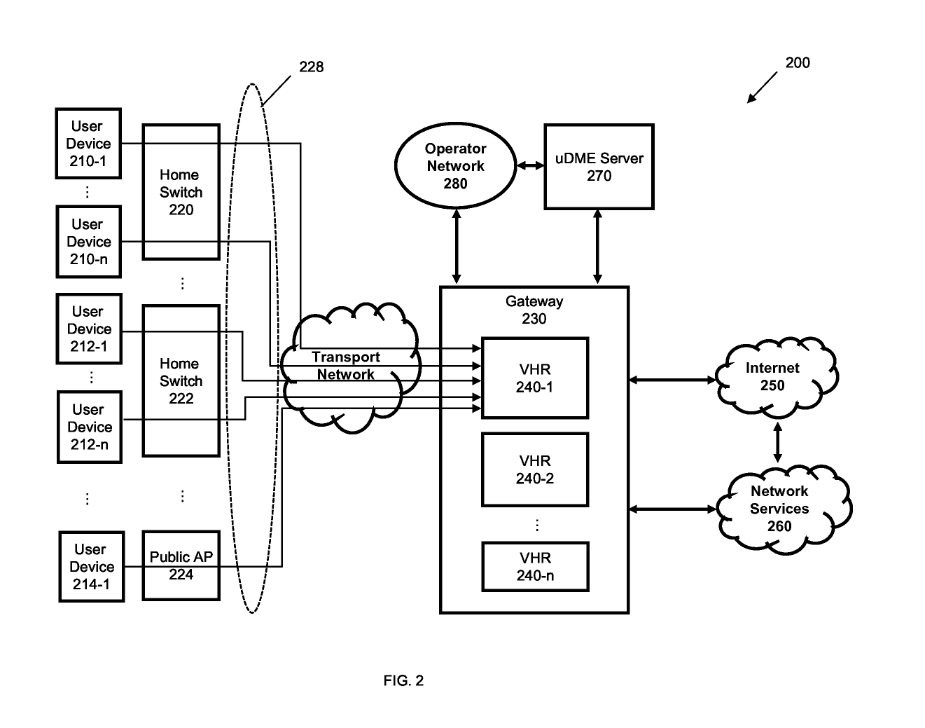

Embodiments of the disclosed subject matter can be implemented in a networked computing environment. FIG. 2 illustrates an exemplary home networking arrangement 200 in accordance with certain embodiments of the disclosed subject matter. The arrangement 200 can include one or more user devices 210-1 . . . 210-n, 212-1 . . . 212-n, and 214-1, one or more home switches 220 and 222, a public access point (AP) 224, a gateway 230, an Internet 250, network services 260, user device management entity (uDME) server 270, and operator network 280. The one or more user devices can be any computing devices capable of accessing network service (e.g., laptop, desktop, tablet, smartphone, smart appliance, networked printer, etc.). The user devices 210-1 . . . 210-n can connect to the home switch 220. The user devices 212-1 . . . 212-n can connect to the home switch 222. The user device 214-1 can connect to the public AP 224. The one or more user devices can be located in different physical locations far apart from each other (e.g., a home, an office, a hotel, a public park, etc.).

In some embodiments, the gateway 230 can be part of a core network (e.g., the core network 130 in FIG. 1). The gateway 230 can support one or more virtual home routers (VHRs) 240-1, 240-2 . . . 240-n. VHRs can support common features associated with a physical home router/gateway, e.g., DNS, UPnP, DHCP server, NAT, etc. The reference number 240 can be used to refer to a virtual home router individually or multiple virtual home routers collectively. In some embodiments, the virtual home router 240 can be a virtual IP router (VIPR). The user device 210, 212, 214 can connect to the gateway 230 and the virtual home router(s) though a transport network. In some examples, the transport network can be a Level 2 IP transport network. Virtual point-to-point (P2P) connections 228 can be established between the user devices 210, 212, 214 and a virtual home router 240. In some embodiments, the virtual P2P connection can be established through encapsulation. In some embodiments, the encapsulation can be a Layer 2 (L2) encapsulation.

In some embodiments, the user devices connected to different home switches 220 and 222 and public AP 224 can connect to the same virtual home router (e.g., 240-1), although the user devices might be located far apart physically. The user devices connected to the same virtual home router, e.g. though virtual P2P connections, can formed a virtual local network (e.g., a virtual home/office network). The user devices in the same virtual local network can access the network resources which are normally available only within the same local network (e.g., printing, content server, uPnP server, etc.). A virtual home router 240 can be uniquely associated with a virtual home router context, which can identified by a unique ID or tag. The virtual home router 240 can also maintain a network address pool (e.g., IP address pool) to be allocated to user devices connected to the virtual home router 240. Additional descriptions about the gateway 230 are in later sections of this disclosure.

Still referring to FIG. 2, the gateway 230 can connect to the Internet 250 and network services 260. The gateway 230 can connect to the network services 260 directly and/or through the Internet 250. The network services 260 can provide various services to the gateway 230 and/or the user devices connected to the gateway. Some examples of the network services 260 can include network DVR, video on demand (VOD), and personal cloud. The network services 260 can also include mobile network operator (MNO) and roaming operator.

In some embodiments, the gateway 230 can also connect to the uDME server 270 and the operator network 280. The gateway 230 can connect to the operator network 280 directly and/or through the uDME server 270. The uDME server 270 can provide managing service for the user devices connected to the gateway 230. The uDME server 270 can optionally include an auto configuration server communicating with and configuring the one or more user devices. In some embodiments, the auto configuration server can handle initial configuration of user devices, e.g., via TR-069/181 protocol. Additional descriptions about the uDME server 270 are in later sections of this disclosure. The operator network 280 can include various servers, such as a policy server, an operation/business support system tool (OSS/BSS) server, an authentication, authorization, and accounting (AAA) server, a domain name system (DNS) server, and a captive portal. In some embodiments, the operator network can be provided by a network operator.

The network arrangement 200 can support cloud-based virtual local networks and support networking as a service (NaaS). The network arrangement 200 can allow physically apart user devices to join a same virtual local network and access the network services which are otherwise not available. The network arrangement 200 can also allow management of user devices, e.g., located in a user's premise. For example, the status of user devices can be managed centrally, e.g., through the gateway 230 and/or uDME server 270. The status of user devices can include when a user device comes online, what kind of device it is, where the user device is, and who is using the user device, etc. In addition, the network arrangement 200 can also enable user/network policies (e.g., residential, outdoor, small business, large corporation, etc.) to be directly applied to the user devices. This can lead to new user cases, which can generate new revenue potentials for broadband service providers. Furthermore, the network arrangement can support “dumb edge-smart core” networking, moving network intelligence from a user-managed home router (e.g., 120 in FIG. 1) to a centrally-managed gateway (e.g., 230 in FIG. 2). This arrangement can thus reduce the cost for users to operate their home networks. For example, home routers with network intelligence capabilities can be replaced with a thin switch.

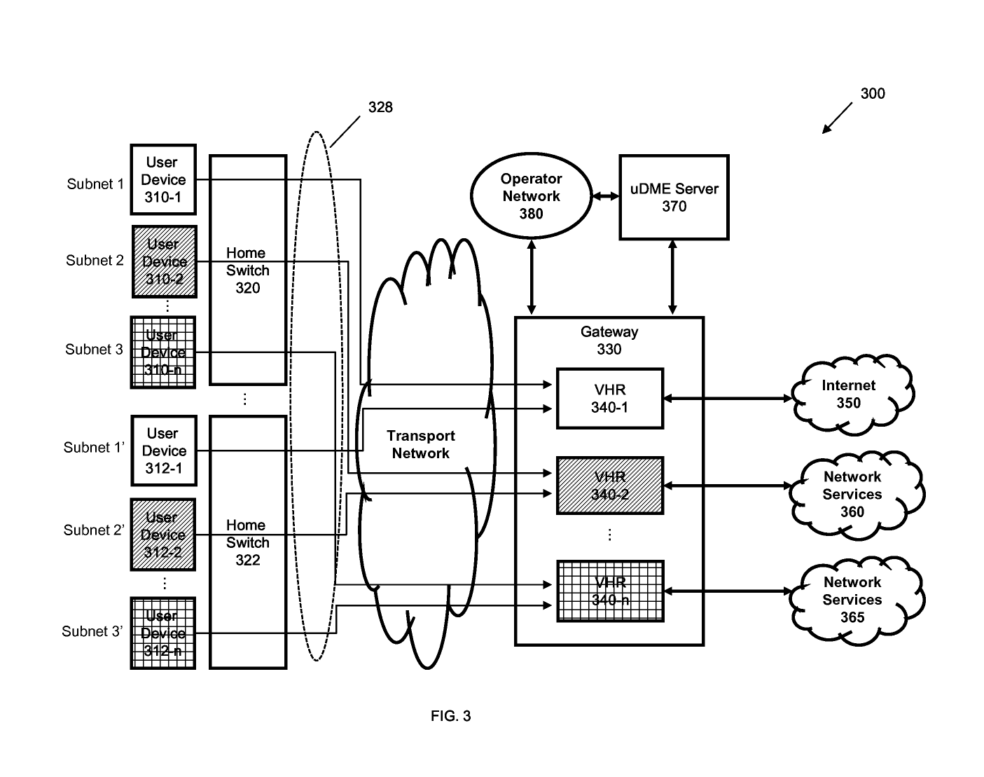

FIG. 3 illustrates another exemplary home networking arrangement 300 in accordance with certain embodiments of the disclosed subject matter. The arrangement 300 can include one or more user devices 310-1, 310-2 . . . 310-n, 312-1, 312-2 . . . 312-n, one or more home switches 320 and 322, a gateway 330, an Internet 350, network services 360 and 365, user device management entity (uDME) server 370, and operator network 380. The one or more user devices can be any computing devices capable of accessing network service (e.g., laptop, desktop, tablet, smartphone, smart appliance, networked printer, etc.). The user devices 310-1, 310-2 . . . 310-n can connect to the home switch 320. The user devices 312-1, 312-2 . . . 312-n can connect to the home switch 322. The one or more user devices can be located in different physical locations far apart from each other (e.g., a home, an office, a hotel, a public park, etc.).

In some embodiments, the gateway 330 can be part of a core network (e.g., the core network 130 in FIG. 1). The gateway 330 can support one or more virtual home routers (VHRs) 340-1, 340-2 . . . 340-n. The reference number 340 can be used to refer to a virtual home router individually or multiple virtual home routers collectively. In some embodiments, the virtual home router 340 can be a virtual IP router (VIPR). The user device 310 and 312 can connect to the gateway 330 and the virtual home routers 340 though a transport network. In some examples, the transport network can be a Level 2 IP transport network. Virtual point-to-point (P2P) connections 328 can be established between the user device 310-1 and 312-1 and the virtual home router 340-1. Virtual P2P connections 328 can be established between the user device 310-2 and 312-2 and the virtual home router 340-2. Similarly, virtual P2P connections 328 can be established between the user device 310-n and 312-n and the virtual home router 340-n. In some embodiments, the virtual P2P connection can be established through encapsulation. In some embodiments, the encapsulation can be a Layer 2 (L2) encapsulation.

As illustrated in FIG. 3, on one hand, user devices (e.g., 310-1 and 312-1) that are connected to different home switches (e.g., 320 and 322) can connect to the same virtual home router (e.g., 340-1); on the other hand, user devices (e.g., 310-1, 310-2, and 310-n) that are connected to the same home switch (e.g., 320) can connect to different virtual home routers (e.g., 340-1, 340-2, and 340-n). For example, user device 310-1 and 312-1 can both connect to the virtual home router 340-1 and form a virtual local network including user devices 310-1 and 312-1. The user devices in the same virtual local network can access the network resources which are normally available only within the same local network (e.g., printing, content server, uPnP server, etc.). In some embodiments, the user devices (e.g., 310-1, 310-2, and 310-n) connected to the same home switch (e.g., 320) can be separated into different subnets (e.g., subnet 1, 2, or 3). Each subnet can have its own subnet identifier, which can be unique.

Still referring to FIG. 3, each virtual home router can be configured to support different network services. For example, the virtual home router 340-1 can provide connection to the Internet 250; the virtual home router 340-2 can provide connection to the network services 360 (e.g., roaming operator); and the virtual home router 340-n can provide connection to the network services 365 (e.g., cable Wi-Fi). In some embodiments, the connections from the virtual home routers to the Internet 350 or the network services 360 and 365 can be Layer 3 (L3) connections. In one example, a virtual home router can connect to an evolved packet core (EPC) MNO network via a GTP/PMIP interface.

In some embodiments, the gateway 330 can also connect to the uDME server 370 and the operator network 380. The gateway 330 can connect to the operator network 380 directly and/or through the uDME server 370. The uDME server 370 can provide managing service for the user devices connected to the gateway 330. Additional descriptions about the uDME server 370 are in later sections of this disclosure. The operator network 380 can include various servers, such as a policy server, an operation/business support system tool (OSS/BSS) server, an authentication, authorization, and accounting (AAA) server, a domain name system (DNS) server, and a captive portal. In some embodiments, the operator network can be provided by a network operator.

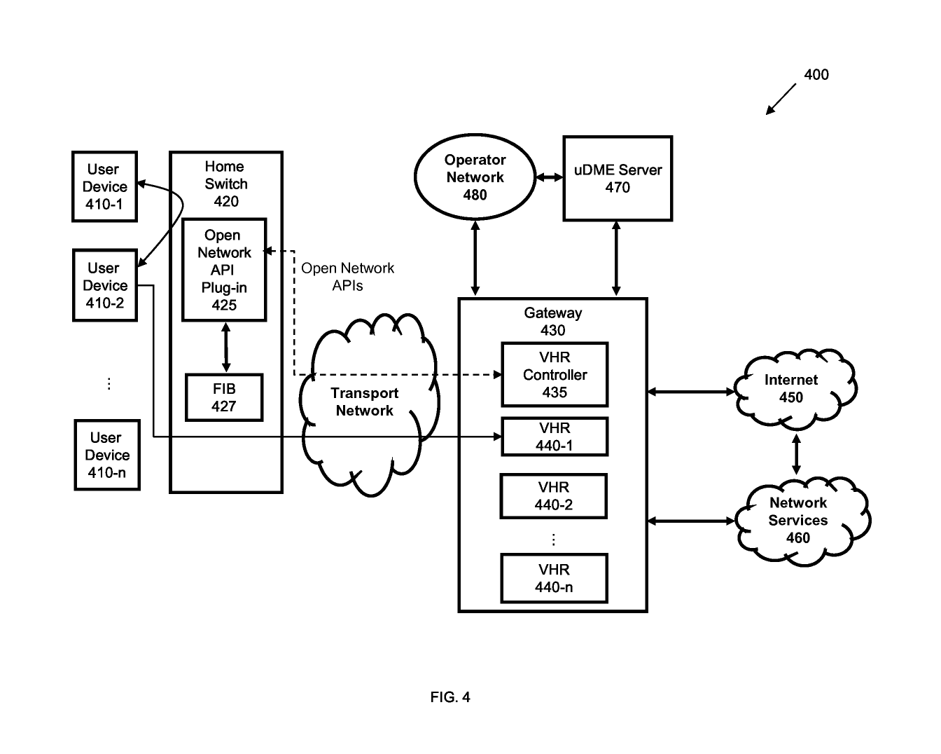

FIG. 4 illustrates another exemplary home networking arrangement 400 in accordance with certain embodiments of the disclosed subject matter. The arrangement 400 can include one or more user devices 410-1, 410-2 . . . 410-n, a home switch 420, a gateway 430, an Internet 450, network services 460, user device management entity (uDME) server 470, and operator network 480. The one or more user devices can be any computing devices capable of accessing network service (e.g., laptop, desktop, tablet, smartphone, smart appliance, networked printer, etc.). The user devices 410-1, 410-2 . . . 410-n can connect to the home switch 420.

In some embodiments, the gateway 430 can also include a virtual home router (VHR) controller 435, which can be configured to communicate with the home switch 420, e.g., via open network APIs. The home switch 420 can also include an open network API plug-in 425 and a forward information base (FIB). The VHR controller 435 can communicate with the open network API plug-in embedded within the home switch 420. The home switch 420 can be managed and configured by the VHR controller 435. In some embodiments, the home switch 420 can be configured to distinguish cloud traffic from local traffic. For example, if the user device 410-1 is a networked printer and the user device 410-2 is a laptop computer, the home switch 420 can be configured so that an Internet browsing request from the user device 410-2 goes through the home switch 420 and reaches to the virtual home router 440-1 while a printing message from the user device 410-2 is forwarded directly to the user device 410-1 without reaching the gateway 430. Distinguishing local network traffic from cloud network traffic can improve performance and efficiency of the network arrangement 400.

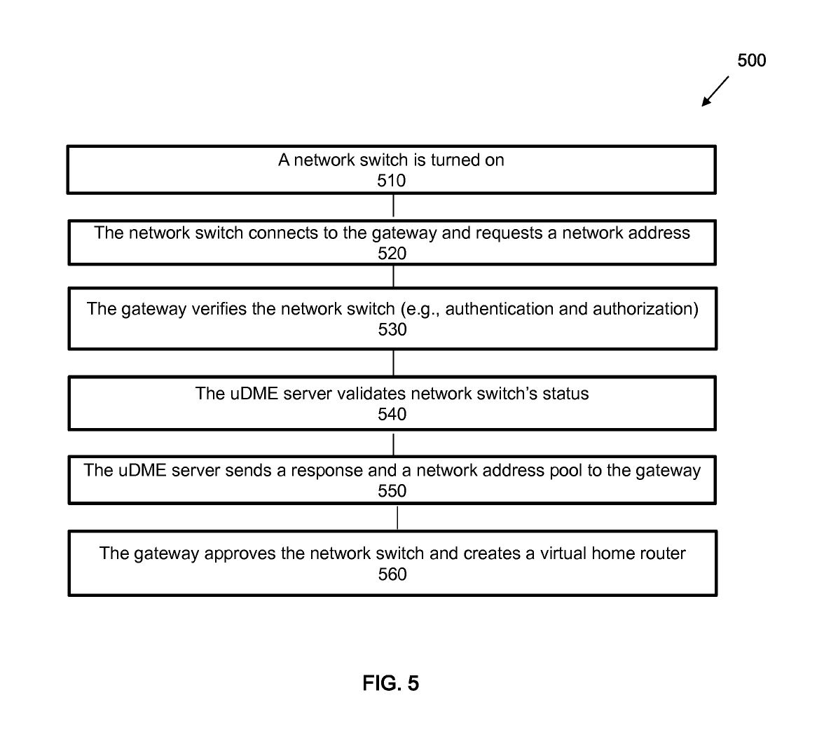

FIG. 5 illustrates an exemplary process 500 of establishing connection between a network switch and a gateway in accordance with certain embodiments of the disclosed subject matter. The process 500 can be modified by, for example, having stages rearranged, changed, added and/or removed.

At stage 510, a network switch (e.g., 220 in FIG. 2) is turned on. In some embodiments, the network switch can be located in a premise of a user (e.g., a home).

At stage 520, the network switch connects to a gateway (e.g., 230 in FIG. 2). In some embodiments, the network switch can send a request for a network address to the gateway. For example, the network switch can send an IP address request to the gateway.

At stage 530, the gateway verifies the network switch. In some embodiments, the gateway can verify authentication and/or authorization of the network switch. In some embodiments, the gateway can communicate with an uDME server to verify authentication and/or authorization of the network switch. In some embodiments, the authentication and/or authorization can be based on a policy. In some embodiments, the gateway can receive a medium access control (MAC) address of the network switch and send the MAC address of the network switch to the uDME server for authentication and/or authorization of the network switch.

At stage 540, the uDME server validates a status of the network switch. In some embodiments, the status of the network switch can be validated based on a policy or a subscription. In some embodiments, the uDME server can validate the status of the network switch though an operator network. In some embodiment, the operator network contains an AAA server.

At stage 550, the uDME server sends a response to the gateway. The response can indicate an acceptance or a denial of the network switch. If the network switch is accepted, the uDME server can also send a network address pool to the gateway. In some embodiments, the network address pool is an IP address pool. Optionally, the uDME server can also send class of service (COS) information to the gateway.

At stage 560, if the response from the uDME server is positive, the gateway approves the network switch and creates a virtual home router for the network switch. In some embodiments, the virtual home router can be associated with a virtual home router context, which can be uniquely identified.

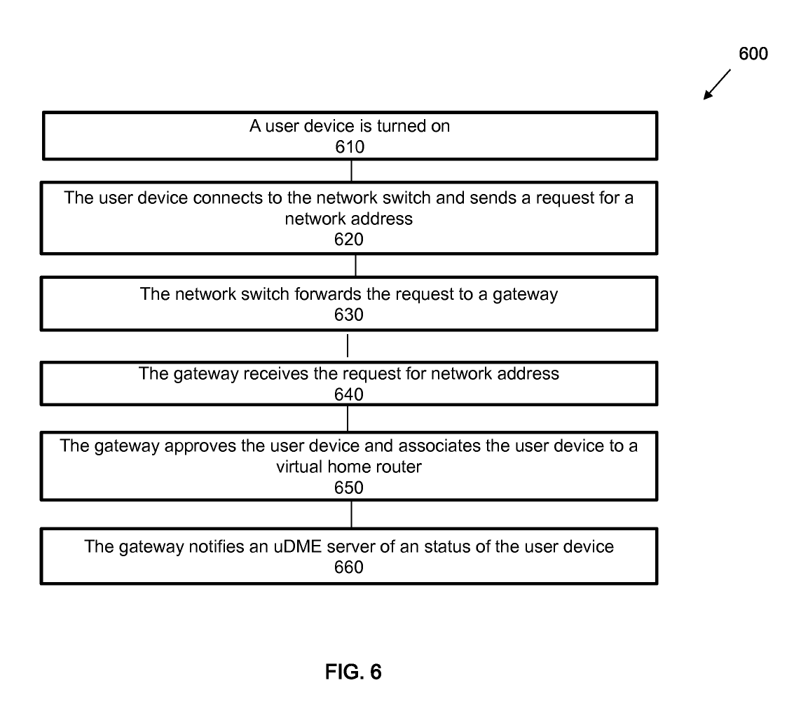

FIG. 6 illustrates an exemplary process 600 of establishing connection between a user device and a gateway in accordance with certain embodiments of the disclosed subject matter. The process 600 can be modified by, for example, having stages rearranged, changed, added and/or removed.

At stage 610, a user device (e.g., 210 in FIG. 2) is turned on. In some embodiments, the user device can be located in a premise of a user (e.g., a home).

At stage 620, the user device connects to a network switch (e.g., 220 in FIG. 2) and sends a request for a network address. In some embodiments, the user device can send a Dynamic Host Configuration Protocol (DHCP) request for an IP address.

At stage 630, the network switch forwards the request to a gateway (e.g., 230 in FIG. 2). In some embodiments, the request can be encapsulated.

At stage 640, the gateway receives the request from the user device.

At stage 650, the gateway approves the user device and associates the user device with a virtual home router. In some embodiments, the gateway can communicate with an uDME server to approves the user device. In some embodiments, the gateway can approve the user device based on a policy. In some embodiments, the network router can also allocate a network address (e.g., an IP address) from a network address pool (e.g., an IP address pool) associated with the virtual home router.

At stage 660, the gateway notifies an uDME server of a status of the user device. Examples of statuses include online/offline status.

In some embodiments, a gateway can monitor status of virtual home routers and the user devices connected to them. The gateway can send reports of the status to an uDME server periodically, automatically, or on demand. The uDME server can store and manage status of the virtual home routers and the user devices connected to them. These information can be stored on per-virtual home router basis in a database on the uDME server. Optionally, the uDME can include a built-in web portal server and provide a virtual home dashboard. A user can log in to the web-based dashboard and manage its user devices (e.g., grouping user devices, setting access control, etc.).

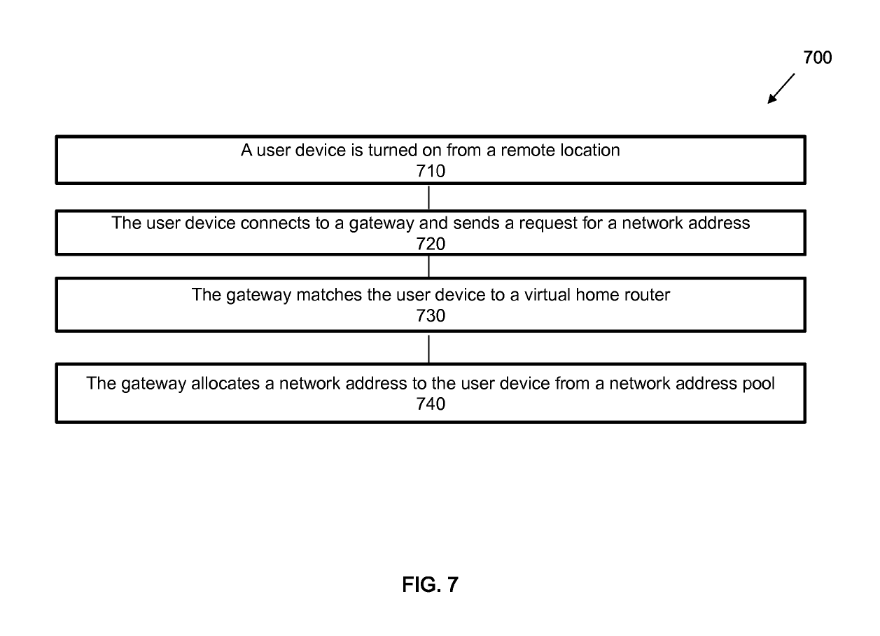

FIG. 7 illustrates another exemplary process 700 of establishing connection between a user device and a gateway in accordance with certain embodiments of the disclosed subject matter. The process 700 can be modified by, for example, having stages rearranged, changed, added and/or removed.

At stage 710, a user device (e.g., 210 in FIG. 2) is turned on. In some embodiments, the user device has been previously connected to a gateway (e.g., 230 in FIG. 2) through a network switch (e.g., 220 in FIG. 2) and has now been moved to a different location. The user device is no longer able to connect to the network switch it used to connect to.

At stage 720, the user device connects to the gateway and sends a request for a network address. In some embodiments, the request is a DHCP request for allocation of an IP address.

At stage 730, the gateway matches the user device with a virtual home router (e.g., 240-1 in FIG. 2). In some embodiments, the virtual home router can contain a virtual home router context, which can be uniquely identified.

At stage 740, the gateway allocates a network address to the user device from a pool of network addresses. In some embodiments, the pool of network address virtual can be associated with the virtual home router or virtual home router context. In some embodiments, the pool of network address virtual is an IP address pool.

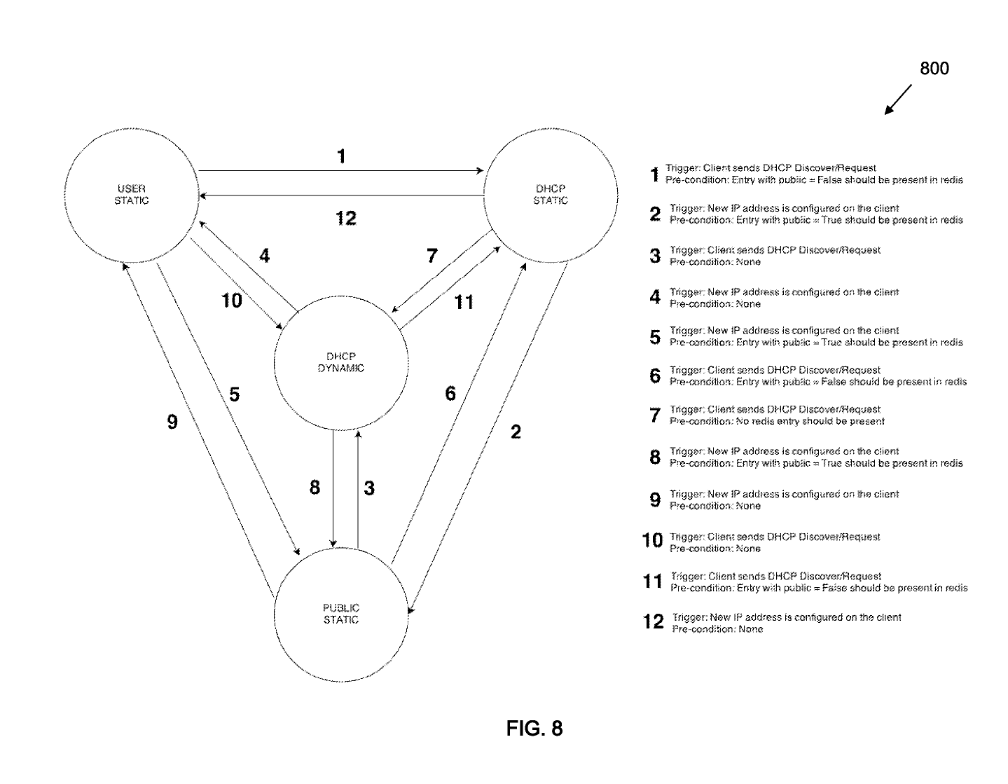

FIG. 8 illustrates an exemplary state diagram 800 of virtual home routers in accordance with certain embodiments of the disclosed subject matter. The state diagram 800 illustrates different states and transitions between states in a virtual home router environment. The state diagram 800 can be modified by, for example, having states rearranged, changed, added and/or removed.

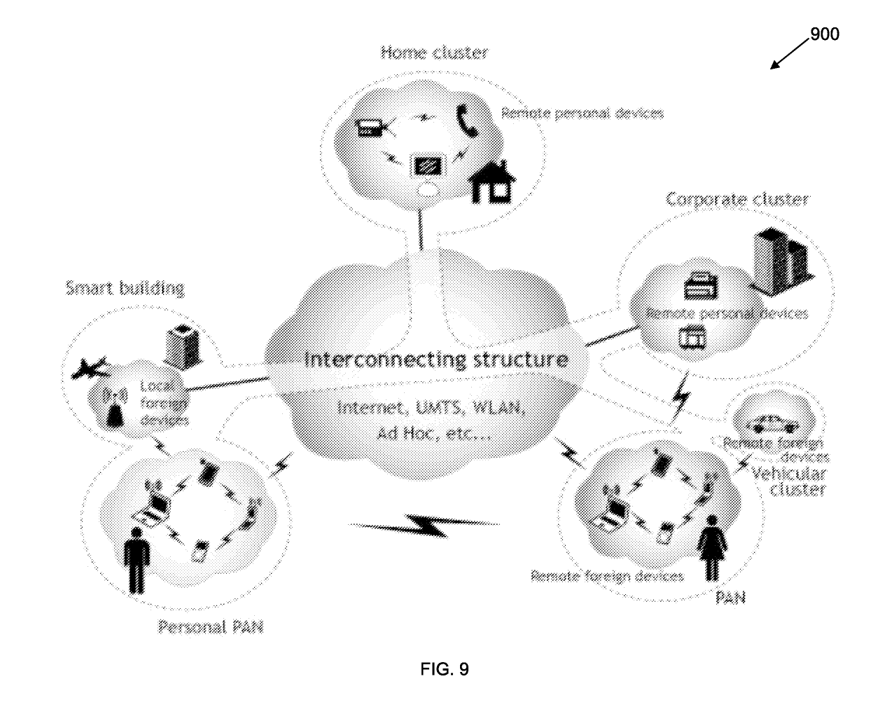

FIG. 9 illustrates an exemplary environment of a virtual local network and the user devices within the virtual local network in accordance with certain embodiment of the disclosed subject matter. As illustrated in FIG. 9, user devices in different physical locations can be connected to the same virtual local network and can access network resources normally available only within the virtual local network (e.g., printing, content server, uPnP server). One application of embodiments of the disclosed subject matter can be to extend multicast/broadcast services (e.g., uPnP) to wide area networks. Details about extending multicast/broadcast services to wide area networks can be found in U.S. patent application Ser. No. 14/077,561 filed on Nov. 12, 2013, which is incorporated herein by reference in its entirety.

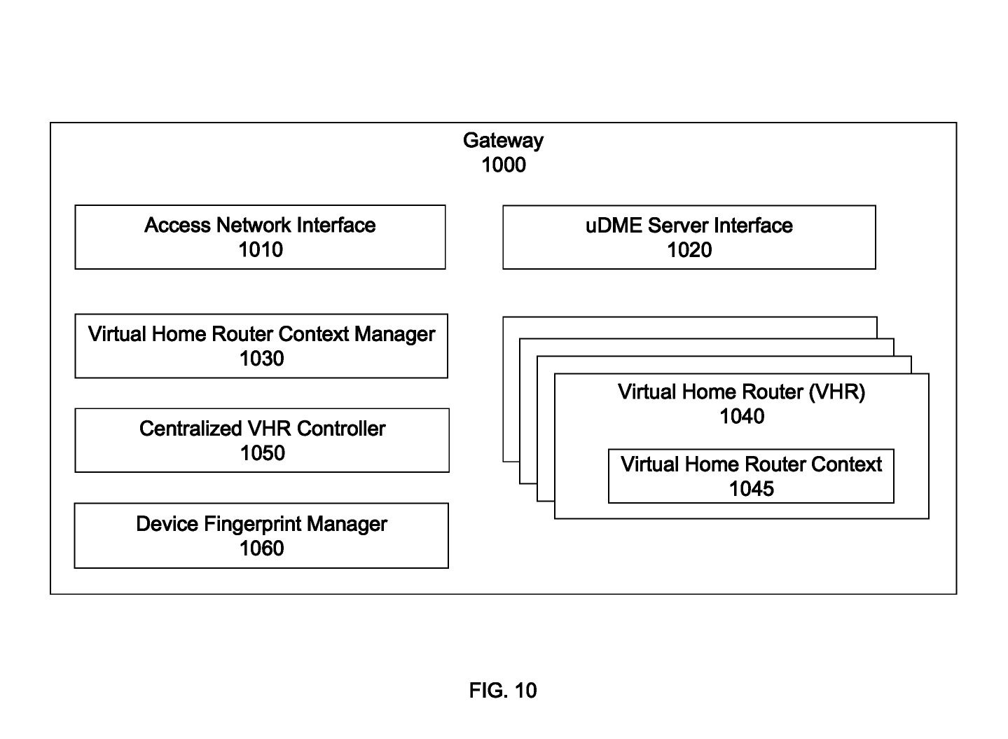

FIG. 10 contains a block diagram of an exemplary network gateway 1000 in accordance with certain embodiments of the disclosed subject matter. The gateway 1000 can include an access network interface 1010, an uDME server interface 1020, a virtual home router context manager 1030, a plurality of virtual home routers (VHRs) 1040, a centralized VHR controller 1050, and optionally a device fingerprint manager 1060. Each VHR 1040 can include a virtual home router context 1045. The gateway 1000 can include additional modules, fewer modules, or any other suitable combination of modules that perform any suitable operation or combination of operations. Two or more components can be combined or merged. Certain function can be split among two or more components.

The access network interface 1010 can serve as the communication interface between network switches (e.g., located at users' premises) and the gateway 1000. For example, the access network interface 1010 can serve as the communication interface between the gateway 1000 and home switches (e.g., 220 in FIG. 2). In some embodiments, the access network interface 1010 can receive/send requests and messages between network switches and user devices, and the gateway 1000.

The uDME server interface 1020 can serve as the communication interface between the gateway 1000 and an uDME server which can provide managing services to the gateway 1000. For example, the uDME server interface 1020 can serve as the communication interface between the gateway 1000 and an uDME server (e.g., 270 in FIG. 2). In some embodiments, the access network interface 1010 can receive/send requests and messages between an uDME server and the gateway 1000.

The virtual home router context manager can manage a plurality of virtual home routers (VHRs) 1040. Each of the virtual home routers can contain a virtual home router context. In some embodiments, a virtual home router context can contain information related to an associated virtual home router. For example, a virtual home router context can contain policy information and can also contain a pool of available network addresses (e.g., IP addresses). In some embodiments, each of the virtual home router context can be uniquely identified by, e.g., an ID or a tag.

The centralized VHR controller 1050 can communicate with user devices connected to the gateway 1000. In some embodiments, the centralized VHR controller 1050 can communicate with open network API plug-ins embedded in the user devices and configure the user devices, e.g., via open network APIs.

The device fingerprint manager 1060 can obtain and manage fingerprints for user devices. In some embodiments, the device fingerprint manager 1060 can determine a fingerprint of a user device when it connects to the gateway 1000. For example, the device fingerprint manager 1060 can identify the device type (e.g., a Windows laptop, an iPad, an Android smartphone, an Apple TV, etc.) of a user device based on, e.g., communication behaviors (e.g., DHCP/IP/MAC communication behaviors).

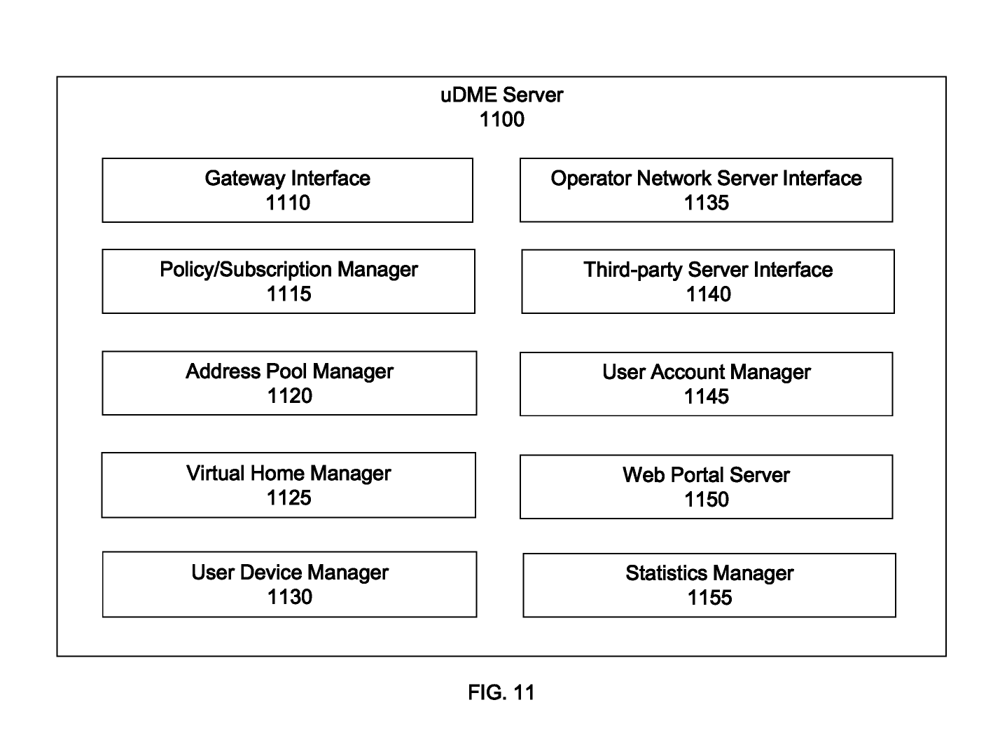

FIG. 11 contains a block diagram of an exemplary uDME server 1100 in accordance with certain embodiments of the disclosed subject matter. The uDME server 1100 can include an gateway interface 1110, a policy/subscription manager 1115, an address pool manager 1120, a virtual home manager 1125, a user device manager 1130, an operator network server interface 1135, a third-party server interface 1140, a user account manager 1145, a web portal server 1150, and a statistics manager 1155. The uDME server 1100 can include additional modules, fewer modules, or any other suitable combination of modules that perform any suitable operation or combination of operations. Two or more components can be combined or merged. Certain function can be split among two or more components.

The gateway interface 1110 can serve as the communication interface between the uDME server 1100 and a gateway which can provide multiple virtual home routers to user devices. For example, the gateway interface 1110 can serve as the communication interface between the uDME server 1110 and a gateway (e.g., 230 in FIG. 2). In some embodiments, the gateway interface 1010 can receive/send requests and messages between the uDME server 1110 and a gateway.

The policy/subscription manager 1115 can manage policy (users and/or system) and/or subscription information for users and user devices. In one example, a policy can prohibit a certain user device or a certain type of user devices from connecting to a gateway. In another example, subscription information can determine how many user devices of a user can be connected to the gateway or how fast a connection can be allowed.

The address pool manager 1120 can manage network address pools for a gateway. In some embodiments, the network address pools are IP address pools. The network address pool for a particular virtual home router can be set by default and can also be configurable by system administrators.

The virtual home manager 1125 can manage virtual local networks created by a gateway. The user device manager 1130 can manage user devices connected to the gateway. In some embodiments, the uDME server 1100 can receive status updates for virtual local networks and user devices from the gateway. Examples of status updates can include online, offline, idle, active, etc.

The operator network server interface 1135 can serve as the communication interface between the uDME server 1100 and an operator network server. For example, the operator network server interface 1135 can serve as the communication interface between the uDME server 1110 and an operator network (e.g., 280 in FIG. 2). In some embodiments, the operator network server can include an authentication, authorization, and accounting (AAA) server.

The third-party server interface 1140 can serve as the communication interface between the uDME server 1100 and a third-party server. In some embodiments, the uDME can have trigger points and/or service logic APIs for third-party provided services. In some embodiments, the service triggers can control a virtual local network and its associated user devices. In some embodiments, third-party services can interact with virtual local network and virtual home router contexts via the third-party server interface 1140. In some embodiments, the APIs between the uDME server and a third-party server can be RESTful based APIs.

The user account manager 1145 can manage user accounts for the user devices connected to the gateway. In some embodiments, an user account can contain user profiles, preferences, configurations, and associated user devices. In some embodiments, the user account manager 1145 can interact with other components of the uDME server such as the policy/subscription manager 1115 to manage user accounts.

The web portal server 1150 can support a built-in web portal for the uDME server 1100. Users can login and access their user accounts via the built-in web portal. In some embodiments, a user can login to the web portal and configure its user account. For example, a user can add/remove/change its user devices; a user can also group its user devices into different subgroups or subnets.

The statistics manager 1155 can manage and maintain statistics relating to the gateway, virtual homes, and user devices. For example, the statistics manager can keep track the network usage and/or average online time of user devices.

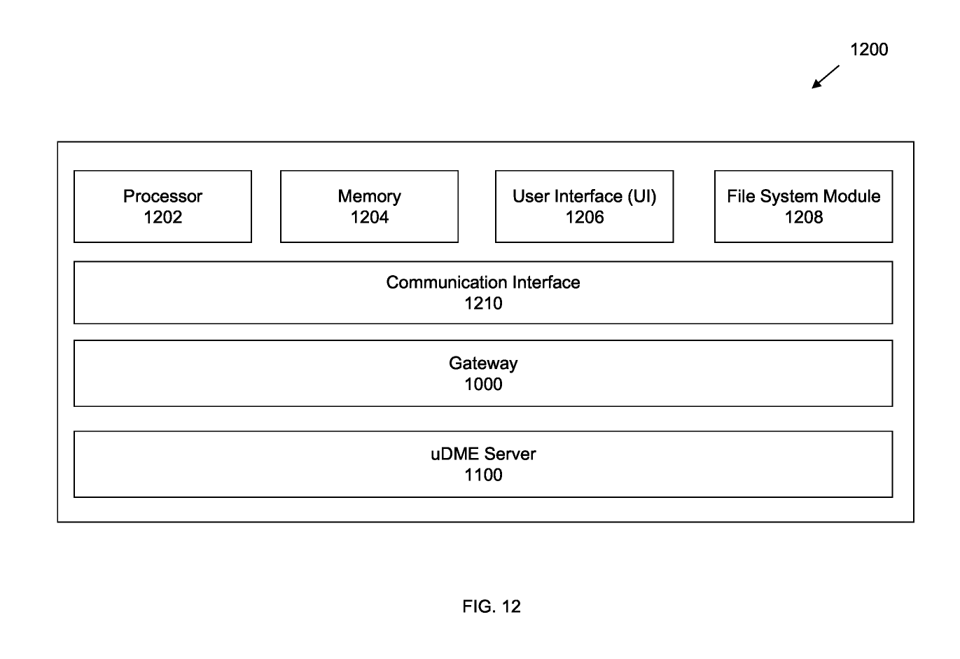

FIG. 12 illustrates a block diagram of an exemplary computing device 1200 according to certain embodiments of the disclosed subject matter. The computing device 1200 can include at least one processor 1202 and at least one memory 1204. The processor 1202 can be hardware that is configured to execute computer readable instructions such as software. The processor 1202 can be a general processor or be an application specific hardware (e.g., an application specific integrated circuit (ASIC), programmable logic array (PLA), field programmable gate array (FPGA), or any other integrated circuit). The processor 1202 can execute computer instructions or computer code to perform desired tasks. The memory 1204 can be a transitory or non-transitory computer readable medium, such as flash memory, a magnetic disk drive, an optical drive, a programmable read-only memory (PROM), a read-only memory (ROM), a random access memory (RAM), or any other memory or combination of memories.

The computing device 1200 can also optionally include a user interface (UI) 1206, a file system module 1208, and a communication interface 1210. The UI 1206 can provide an interface for users to interact with the computing device 1200 in order to access the gateway 1000 and/or uDME server 1100. The file system module 1208 can be configured to maintain a list of all data files, including both local data files and remote data files, in every folder in a file system. The file system module 1208 can be further configured to coordinate with the memory 1204 to store and cache files/data. The communication interface 1210 can allow the computing device 1200 to communicate with external resources (e.g., a network or a remote client/server). The computing device 1100 can also include a gateway 1000 and/or a uDME server 1100. The description of the gateway 1000 and the uDME server 1100 and their functionalities can be found in the discussion of FIGS. 1-11. The computing device 1200 can include additional modules, fewer modules, or any other suitable combination of modules that perform any suitable operation or combination of operations.

In addition, embodiment systems can support standard-based communication protocols and enhanced optimizations for implementation of a Wireless Access Gateway (WAG) for providing IP access services to 802.11 family of Wi-Fi networks, a GPRS Service Node (GGSN) function as specified by 3^{rd} Generation Partnership Project (3GPP) standards in TS 23.002, SGW and PGW as specified in TS 23.401, or PDG as specified in 23.234. An embodiment system can also support standard-based communication protocols for implementation of a PDSN/HA functions as specified by 3GPP2 standards in the CDMA2000 Wireless IP Network Standard (3GPP2 X.S0011-001-E v1.0). An embodiment system can further support standard-based communication protocols for implementation of ASN-GW/HA functions as specified by WiMAX standards in WiMAX Forum Network Architecture (WiMAX Forum Document Number WMF—T32-002-R010v04, Feb. 3, 2009).

The systems and methods described in the disclosed subject matter can be implemented with various network technologies. A Mobile Evolved Gateway (MEG) open programmable mobile internet gateway can perform more than one functions while integrating different functionalities. The MEG open programmable mobile internet gateway can perform as Gateway General packet radio service Support Node (GGSN), GPRS support node (SGSN), mobility management entity (MME), a packet data serving node (PDSN), a foreign agent (FA), or home agent (HA), an HRPD serving gateway (HSGW), a serving gateway (SGW), a packet data network gateway (PGW), an access service network gateway (ASNGW), packet data inter-working function (PDIF), packet data gateway (PDG), or a Wi-Fi gateway. In certain embodiments, one or more of the abovementioned other types of functionalities are integrated together or provided by the same gateway.

The MEG open programmable mobile internet gateway can also support sessions originated from a femto base station or a Wi-Fi access point over a secure connection, which can connect to the MEG open programmable mobile internet gateway using a broadband network. The gateway can provide trigger based traffic management during a handoff from a small cell base station or wi-fi access point to a macro base station, while maintaining traffic management for the mobile node and preservation of IP address. In certain embodiments the gateway is used as offload device to offload traffic off the macro cellular licensed spectrum to femto or Wi-Fi base stations.

The systems described in the disclosed subject matter can be implemented in hardware and/or software. The software can run on multi blade, multi CPU with multiple processing cores. The operating system software can be based on a Linux software kernel and run specific applications in the gateway and providing protocol stacks.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

For example, although the present disclosure sometimes uses the terms such as “home,” “home router,” “home switch,” “home network,” or “home networking,” the disclosed subject matter is not limited to the context of a home but can be applied to other physical and/or logical settings (e.g., office, private or public places, etc.)

A “server,” “client,” “agent,” “module,” “manager,” “interface,” and “host” is not software per se and includes at least some tangible, non-transitory hardware that is configured to execute computer readable instructions. In addition, the phrase “based on” does not imply exclusiveness—for example, if X is based on A, X can also be based on B, C, and/or other factor(s).

What is claimed is:

1. A computerized method for providing cloud-based virtual local networks, comprising:
receiving at a network gateway a request for a network address from a network switch;
communicating with a user device management entity (uDME) server to authorize the network switch;
receiving an authorization response from the uDME server for the network switch;
receiving a network address pool at the network gateway from the uDME server; and
creating at the network gateway a virtual home router containing a virtual home router context that is unique to the virtual home router and associated with the network address pool.

2. The computerized method of claim 1, wherein the network switch is located in a premise of a user.

3. The computerized method of claim 1, wherein the network address is an IP address.

4. The computerized method of claim 1, wherein the virtual home router is a virtual IP router.

5. The computerized method of claim 1, wherein the network address pool is an IP address pool.

6. The computerized method of claim 1, further comprising authorizing the network switch based on a policy.

7. The computerized method of claim 1, further comprising:
receiving at the network gateway a medium access control (MAC) address of the network switch; and
sending the MAC address of the network switch to the uDME server for authorizing the network switch.

8. The computerized method of claim 1, further comprising receiving class of service (COS) information from the uDME server.

9. The computerized method of claim 1, further comprising:
receiving at the network gateway a second request for a second network address from a user device connected to the network switch;
authorizing the user device for network access;
associating the user device with the virtual home router at the network gateway;
allocating the second network address from the network address pool associated with the virtual home router; and
notifying the uDME server of a status of the user device.

10. The computerized method of claim 9, wherein the second request is encapsulated and forwarded by the network switch.

11. The computerized method of claim 9, further comprising communicating with the uDME server to authorize the user device for network access.

12. The computerized method of claim 9, further comprising authorizing the user device for network access based on a policy.

13. The computerized method of claim 9, further comprising:
receiving at the network gateway a third request for a third network address from the user device when the user device is not connected to the network switch;
authorizing the user device for network access;
associating the user device with the virtual home router at the network gateway;
allocating the third network address from the network address pool associated with the virtual home router; and
notifying the uDME server of the status of the user device.

14. A network gateway for providing cloud-based virtual local networks, comprising:
an access network interface configured to receive a request for a network address from a network switch;
a user device management entity (uDME) server interface configured to send an authorization request to an uDME server and receive an authorization response; and
a virtual home router context manager configured to maintain at least one virtual home router context and create a virtual home router for the network switch based on the authorization response.

15. The network gateway of claim 14, wherein the authorization response contains a network address pool for the virtual home router.

16. The network gateway of claim 14, wherein the authorization response contains class of service (COS) information.

17. The network gateway of claim 14, wherein
the access network interface is further configured to receive a media access control (MAC) address of the network switch; and
the uDME server interface is further configured to send the MAC address of the network switch for authorization.

18. The network gateway of claim 14, further comprising a centralized virtual home router controller configured to configure at least one user device.

19. The network gateway of claim 14, further comprising a device fingerprint manager configured to determine a device type of a user device.

20. The network gateway of claim 14, wherein
the access network interface is further configured to receive a second request for a second network address from a user device connected to the network switch;
the uDME server interface is further configured to authorize the user device for network access; and
the virtual home router context manager is further configured to associate the user device with the virtual home router.

21. The network gateway of claim 20, wherein the uDME server interface is further configured to notify the uDME server of a status of the user device.

22. A network server for providing cloud-based virtual local networks, comprising:
a network gateway interface configured to communicate with a network gateway supporting virtual home routers;
an operator network server interface configured to communicate with an operator network server;
a subscription manager configured to manage subscriptions of a plurality of users;
a network address pool manager configured to manage network address pools for a plurality of virtual home routers;
a virtual home manager configured to manage a plurality of virtual homes; and
a user device manager configured to manage a plurality of user devices.

23. The network server of claim 22, further comprising a third-party server interface configured to communicate with a third-party server to provide additional services to user devices coupled to a virtual home router.
